(19) United States
(12) Patent Application Publication
(10) Pub. No.: US 2006/0060185 A1
(43) Pub. Date: Mar. 23, 2006

(54) Device and method for converting movement energy into heat

(76) Inventor: Michael C. Dehn, Hamburg (DE)

Correspondence Address: Norris, McLaughlin & Marcus P.A., 18th Floor, 875 Third Avenue, New York, NY, 10022, US

(21) Appl. No.: 11/134,980

(22) Filed: May 23, 2005

(30) Foreign Application Priority Data
May 21, 2004 (DE) 10 2004 025 987.9
Oct. 15, 2004 (DE) 10 2004 050 837.2
Sep. 7, 2004 (DE) 20 2004 014 225.2
Oct. 15, 2004 (DE) 20 2004 016 185.0

(51) Int. Cl. F02B 41/00; F24C 9/00

(52) U.S. Cl. 126/247; 122/26

(57) ABSTRACT

The invention relates to a device and to a method for converting movement energy into heat. Movement energy is understood here to be the energy generated especially by the movement of people while running, riding a bike, riding a horse, etc.

The heat is generated by two molded parts (1, 2), which are disposed one behind the other in the main direction of movement, at least one of which consists of a polymeric plastic and is movable elastically, and which are structured at their mutually facing surfaces so that, when the molded parts (1, 2) move one upon the other, surface friction, which generates frictional heat, results.

The invention relates to a device and to a method for converting movement energy into heat. In this connection, movement energy is understood to be, in particular, the heat developed when a person is moving, for example, running, riding a bicycle, riding a horse, etc. The device, for example, is to be suitable for building up the soles of shoes, with which heat is developed within a shoe while running.

The possibilities for heating surfaces, for example, by conventional footwear comprise essentially the use of electrical heating elements, which mostly generate heat by means of a battery. The usual heating elements may be integrated in the form of an insole in any existing shoe. They are connected by way of a cable with a battery or an accumulator, which is worn on the body. Depending on the output, these systems ensure an operation of approximately 1-6 hours. After this period of use, the batteries or accumulators must be changed or recharged. A different form of the electrical heating elements brings about a more rapid drying of the interior of shoes, by means of which, among other things, the development of bacteria is to be reduced. Systems of this type obtain their energy from the wall socket or the cigarette lighter of a motor vehicle. Heating elements of this solution are mostly shaped as insoles. A further solution consists of slipping a shoe onto an electrically heated shoe stretching device.

The generation of heat by means of a chemical process is a different possibility. For this purpose, sodium acetate (CH₃COONa) may be present as an undercooled melt. Upon crystallization, sodium acetate emits heat of melting or, in this case, heat of crystallization. These so-called heat cushions, which are also known as hand warmers, can be used for heating footwear. An additional, conceivable possibility is the generation of heat by means of a carbon rod, which generates heat by burning up.

The techniques for cushioning shoes essentially consist of using different polymer foams or elastic plastics, which can be compressed only to a slight extent and, by way of a slight emission of heat, achieve a recovery of energy. The usual foam materials can be partly compressed elastically because of the fact that open or closed cells are enclosed in the foam.

Known footwear has, for example, a yielding, compressible, middle sole, which is disposed above an essentially flexible, abrasion-resistant outer sole. Such intermediate soles are produced, for example, from conventional foam materials, such as ethylene vinyl acetate (EVA) or from polyurethane. The outer soles are produced from conventional, abrasion-resistant materials, such as a rubber composite.

Cavities have long been used as a cushion in shoes, in order to increase the comfort of shoes, to increase the hold of the foot, to reduce the danger of injuries and other harmful effects and to decrease rapid fatigue of the feet. In general, the cavities consist of elastomeric materials, which are shaped in such a manner, that they define at least one pocket or chamber under pressure. Typically, a cavity actually defines many chambers, which are disposed in a pattern, which is constructed in such a manner that one or more of the objectives mentioned above is accomplished.

The cavities may be placed under pressure with a number of different media, such as air, different gases, water or other liquids.

However, these aforementioned solutions for generating heat have disadvantages in the form that the generation of heat depends exclusively on external sources of energy, that they are heavy and that they are cost intensive and relatively expensive to manufacture. Moreover, they deliver the heat only to the sole. In addition, they hardly offer the user any wearing comfort, since they depend on batteries or accumulators, which must be worn on the body. Furthermore, they generate heat for only a few hours. Heat cushions also produce heat for only a short time after the chemical process is activated and must then be exchanged for new ones.

Admittedly, foam materials, such as ethylene vinyl acetate (EVA) or polyurethane, which are generally used for the cushioning, can absorb an impact. However, this energy is given off once again only sluggishly or to a slight extent as repulsion energy. Furthermore, these materials have the disadvantage that the elasticity decreases due to frequent compression and may level off more or less permanently. A construction of different layers, which consist of foam materials or rubber, also has the disadvantage that it absorbs the impact only slightly and gives off the energy only sluggishly or to a slight extent as repulsion energy. Cavities of elastomeric materials, which are put under pressure with air, different gases, water or other liquids, have the disadvantage that they also level off and “can reach bottom” if they are subjected to high pressures, such as those encountered in sporting activities. Furthermore, they permit only thick constructions of soles, which limit design possibilities.

With these possibilities for heating shoes, the elimination of moisture and odor, which occur as a result of the moisture and accumulate in the shoe because of foot perspiration, which, in turn, is the result of poor shoe ventilation, generally is made possible only inadequately or by expensive mechanics. The previously known, ventilated shoes contain elastomers and flexible cushions, which are impermeable to air, are produced from soft materials, such as rubber, and have a plurality of holes, through which vapor can emerge to the outside, in the region of the sole. Among other things, they have the disadvantage that they support an exchange of air only passively, that is, only inadequately due to the actions of forces while walking or running. Moreover, passage openings in the region of the soles have the disadvantage that they are closed quickly off by dirt and that, moreover, the heat generated can escape quickly.

It is an object of the invention to create a device and a method for converting movement energy into heat, which use the kinetic energy, resulting from movement, to generate heat and enable the heat to be redistributed. When used to build up the sole of shoes, the venting of the interior of the shoes shall optionally be made possible and the absorption of impacts is to be supported. It shall be possible to produce the device relatively inexpensively in a structurally simple manner without electronic components.

This objective is accomplished with the distinguishing features of claims 1 and 58. Advantageous developments are the object of the dependent claims.

Accordingly, the device consists of two molded parts, which are disposed one behind the other in the main direction of movement and of which at least one consists of a polymeric plastic and can be moved elastically, and which are structured at their mutually opposite surfaces, so that, as the molded parts move towards one another, surface friction results, which generates frictional heat.

The method consists therein that the movement energy, generated by opposite, structured surfaces of two molded parts, of which at least one consists of an elastic, polymeric plastic, is converted into heat by the friction of the structured surfaces against one another.

Compared to previously known solutions, the method has the advantage that a self-regulating effect arises owing to the fact that the frictional resistance of the polymeric plastic decreases with increasing temperature, so that the friction then becomes less and generates less heat. Accordingly, less heat is produced at higher outside temperatures than at lower outside temperatures. The effect is very effective especially if both molded parts consist of a polymeric plastic.

In a preferred manner, provisions are made so that a first molded part has rib-like or nap-like convexities, which engage opposite recesses between convexities of a second molded part, so that the opposite convexities of the first and second molded part rub against one another.

Furthermore, the convexities and the opposite recesses preferably have different angles of inclination.

Advisably, the convexities and the opposite recesses are created ring-shaped or strip-shaped

According to a variation of the invention, the hollow space, formed between the first and second molded parts, may be filled with a gas, a gel or a liquid.

The molded parts may be connected advantageously with latent storage materials, such as microscopically small plastic spheres, which contain a storage medium of wax in their core. Microencapsulated storage media of this type are sold, for instance, under the trade name of Micronal by BASF. When subjected to the action of heat or cold, the wax melts or solidifies in the storage capsules. The energy absorption of these wax-like paraffins is three times as high as that of water. In this way, they regulate the surrounding temperature, that is, if the molded parts produce heat, the latent heat storage systems absorb this heat and, if the heat decreases, for example, while waiting for a bus, they emit heat. The temperature during the phase conversion remains constant. This stored heat, “hidden” in the phase conversion, is referred to as latent heat. This is a reversible process, which takes place in the melting range of the wax.

The latent heat storage system may be provided with an indicator dye, in order to make the temperature changes optically visible.

Advisably, in the unstressed state, the first and second molded parts may, at least partially, be spaced apart, for example, by spacers.

They may also be produced in one piece and connected with a hinge and optionally be provided on the opposite side with a lock.

Alternatively, they may also be glued to one another.

The molded parts advisably are produced from an elastic plastic.

They may also consist of an electroactive or thermoactive polymer. In the case of an electroactive polymer, different material properties can be adjusted by applying an electric voltage. Thermoactive polymers change their properties as the temperature changes.

The molded parts may also be components of the construction of different requisites, in or at which the generation of heat is desirable, such as shoes, saddles, handles, inserts in gloves or textiles, etc.

If the device is part of the construction of the sole of a shoe, the first molded part is constructed as an upper, elastically formed part of the sole and the second molded part as a lower part of the sole, the sole parts being provided at least in the heel region of the shoe.

In a particularly preferred manner, provisions are made so that a hose, in the ring-shaped extent of which at least one one-way passage opening is disposed and which extends from the heel region at least into a further part of the shoe and is filled with a liquid, is located within or beneath the lower part of the sole. The liquid, which has warmed up in the heel region, is circulated by pressure on this region into further regions of the shoe and can emit the heat there.

This measure offers the possibility of converting kinetic energy into heat and of making possible a temperature exchange, which is driven by kinetic energy. The shoes are suitable especially for the colder times of the year or for use in cold regions. The heat, produced at least in the heel region while running, is transported to a region, which is more endangered by the cold, such as the toes. The foot becomes uniformly warm, which produces a pleasant wearing sensation. The danger of freezing is reduced significantly.

In a further, preferred manner, provisions are made so that the upper and the lower parts of the sole in the unstressed state are at least partially at a distance from one another. With that, a space is formed between the upper and lower parts of the sole. The cavity may optionally be filled with a gas, a gel or a liquid. If it is not filled, a constant exchange of air with the outside can take place through venting openings in the sole parts. In addition, provisions can be made that the venting openings are provided in each case with at least one inlet valve and one outlet valve. The air, aspirated at one place, can then be passed to the outlet selectively through specified regions of the sole structure.

According to a further, preferred distinguishing feature of the invention, the upper and lower parts of the sole are produced in one piece and connected with a hinge.

The frictional heat advisably is generated by convexities at one part of the sole and associated concavities at the other, the parts rubbing against one another during a running motion. In order to intensify this effect, the surface of these convexities and concavities maybe roughened, provided with an appropriate coating or structured internally once again, for example, by a scale-like structure.

In order to increase the wearing comfort, an insole, which is then advisably also provided with venting openings, may be provided additionally. However, the sole parts themselves may also be constructed as an insole, so that the heat-generating effect can also be used for other shoes.

Advisably, the sole parts are produced from a thermoplastic material. In so doing, it is possible to make use of the advantage that the flexibility of the material depends on its temperature. If the temperature is low, the flexibility is less so that the frictional resistance increases and generates heat rapidly. On the other hand, as the temperature increases, the frictional resistance decreases, so that a self-regulating effect is brought about.

In the following, the invention is to be explained in even greater detail by means of examples. In the associated drawings,

FIG. 1 shows an inventive device in cross-section,

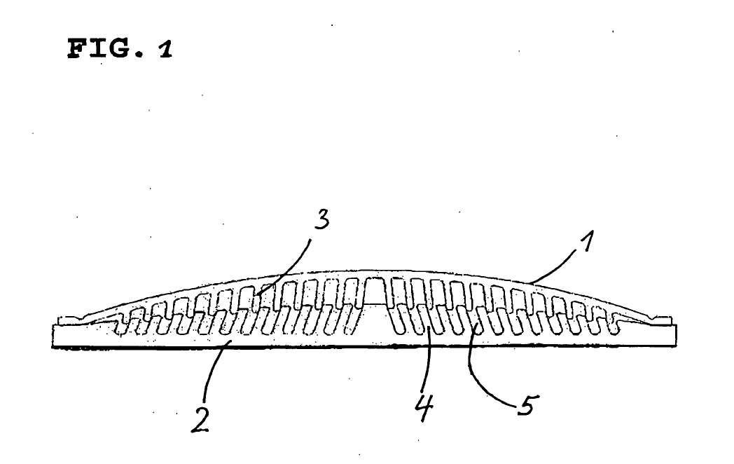

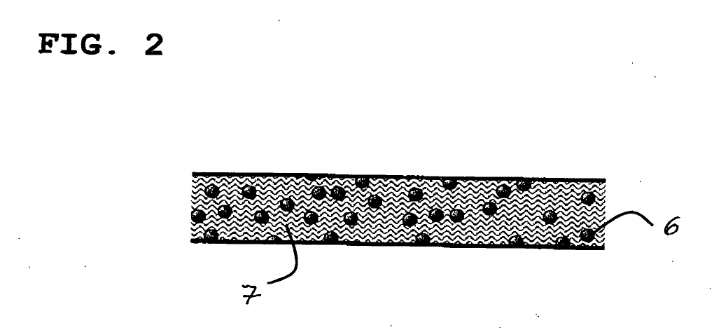

FIG. 2 shows a cross-section through and associated latent heat storage system,

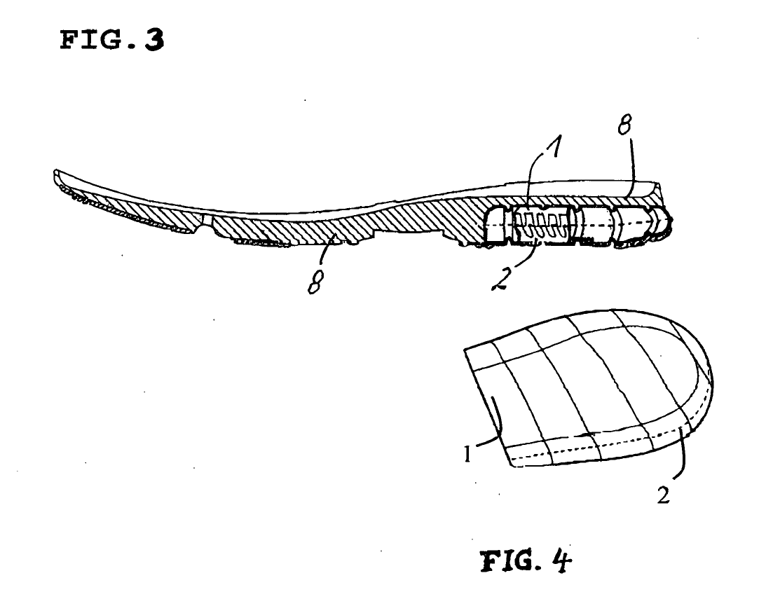

FIG. 3 shows a cross-section of the sole structure of a shoe produced pursuant to the invention,

FIG. 4 shows a plan view of the sole construction of FIG. 3 in the heel region,

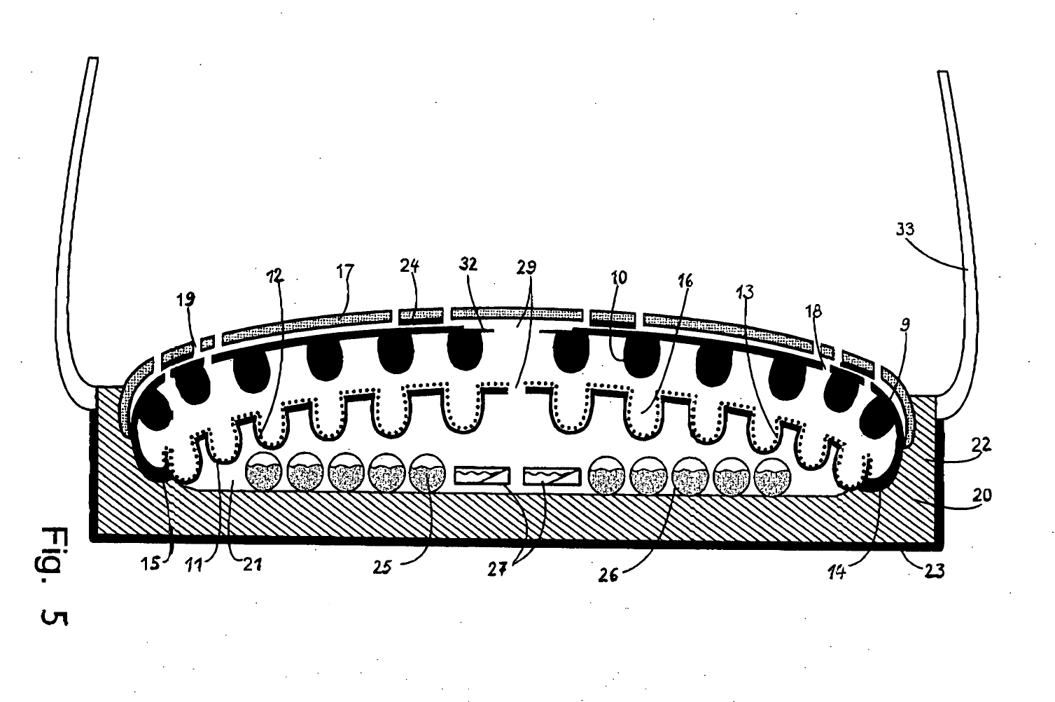

FIG. 5 shows a cross section of a further variation of the sole construction of a shoe, produced pursuant to the invention,

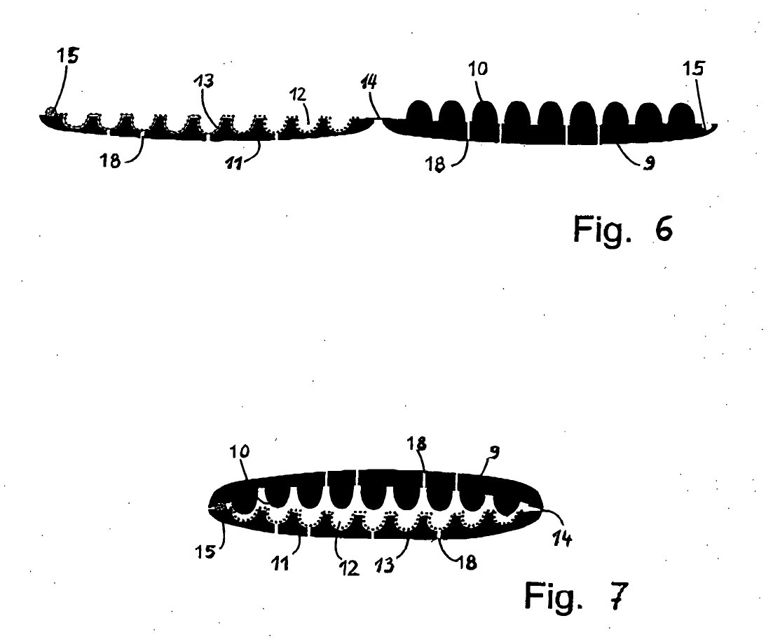

FIG. 6 shows a sectional view of an inventive sole construction, which is intended for use in the heel region, the upper and lower parts of which have not yet been folded together,

FIG. 7 shows a sectional view of a sole construction of FIG. 6 after the folding over,

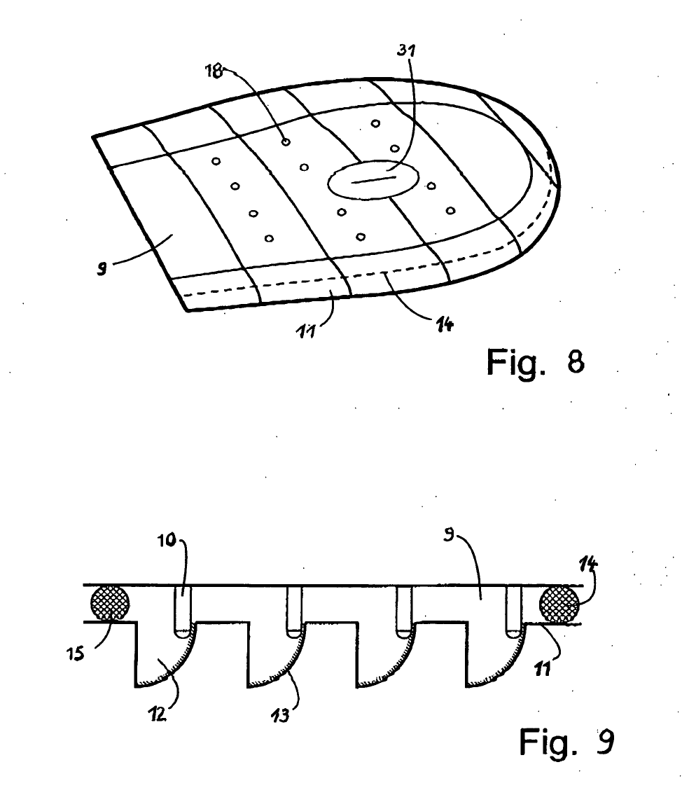

FIG. 8 shows a plan view of a sole construction, which is intended for use in the heel region, the upper and lower parts of which are connected to one another by an inserted connecting bolt,

FIG. 9 shows a sectional view of a further variation of an inventive sole construction,

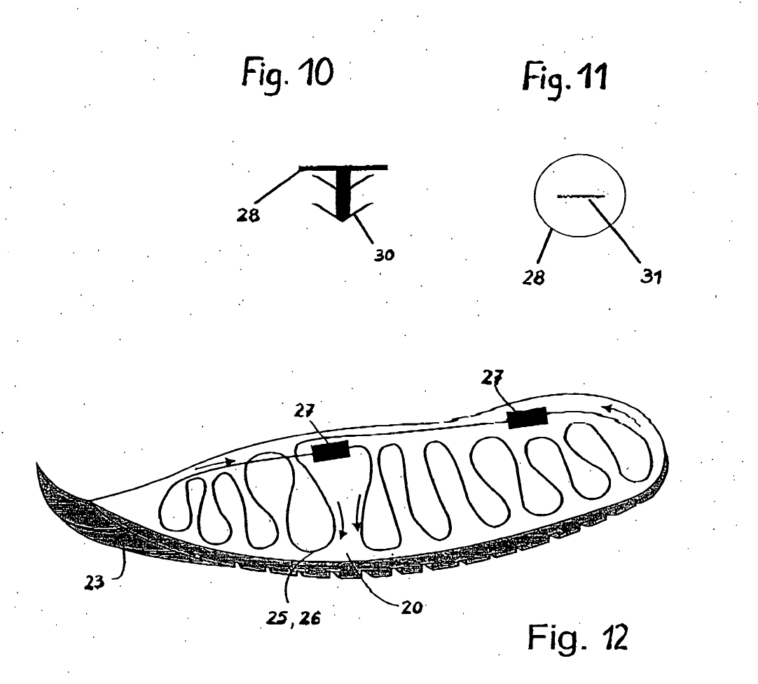

FIG. 10 shows a connecting bolt in a sectional view,

FIG. 11 shows a connecting bolt in a plan view,

FIG. 12 shows the arrangement of a hose and associate valves for transporting the heat generated in the sole,

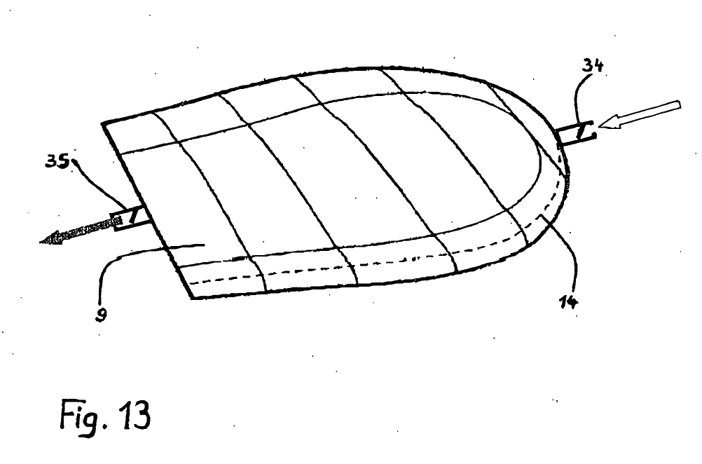

FIG. 13 shows a variation of a sole construction with an inlet valve and an outlet valve for the venting openings,

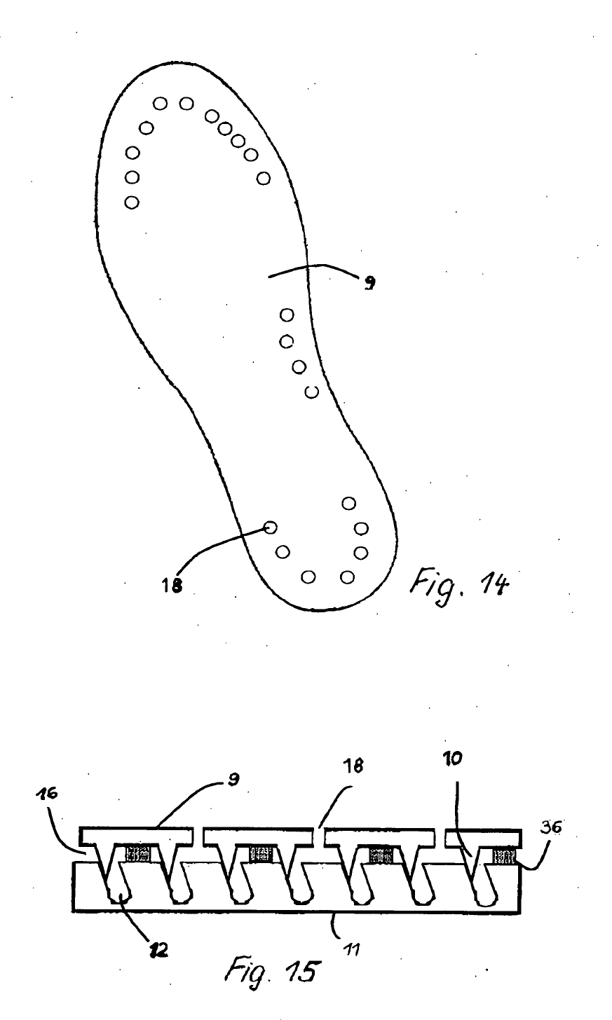

FIG. 14 shows an insole, configured pursuant to the invention,

FIG. 15 shows the insole of FIG. 14 in a sectional representation,

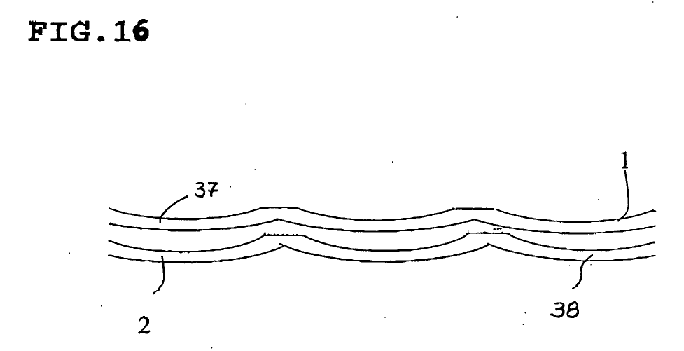

FIG. 16 shows a further variation of the inventive device in cross-section,

FIG. 17 shows another variation of the device in the compressed state,

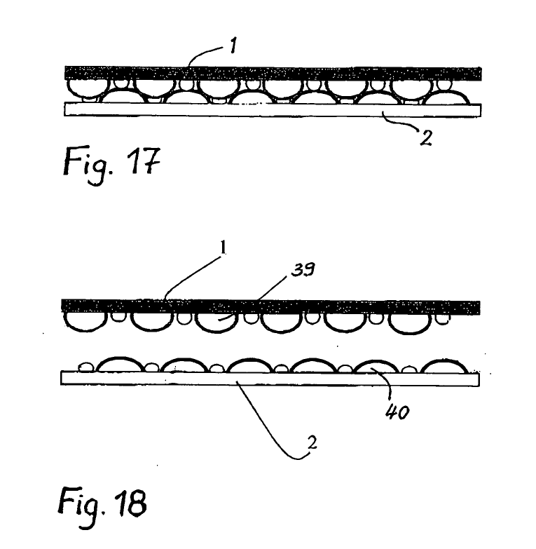

FIG. 18 shows this variation in the separated state,

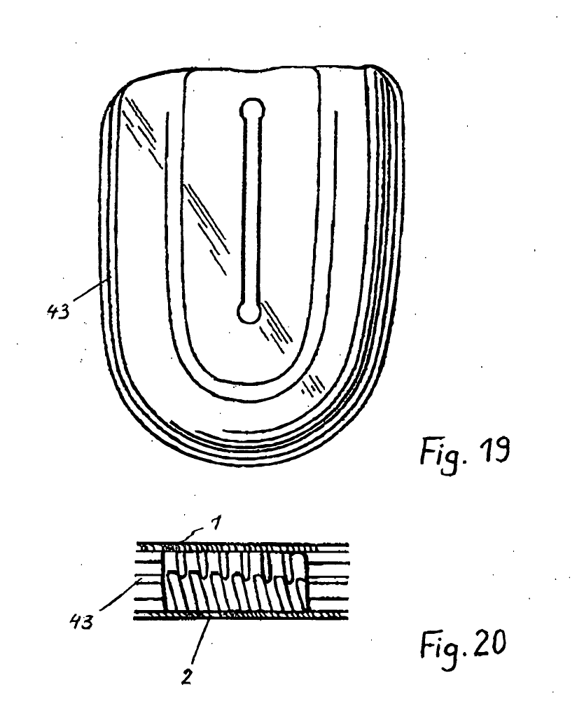

FIG. 19 shows a device, configured as an air cushion, in a plan view,

FIG. 20 shows the air cushion of FIG. 19 in a sectional representation,

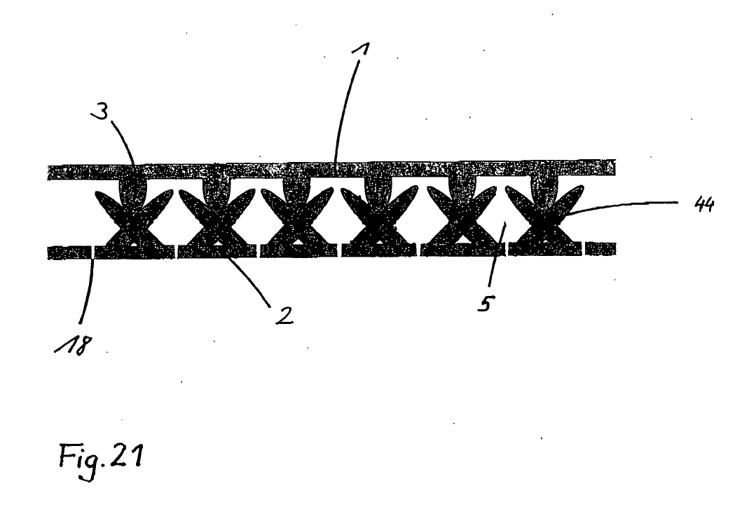

FIG. 21 shows a variation with convexities of a different shape,

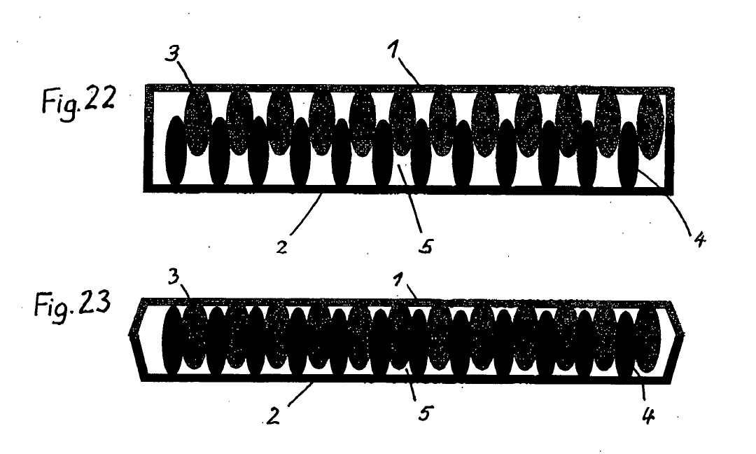

FIG. 22 show a further variation of a special shape of the convexities in the separated state of the molded parts,

FIG. 23 shows the variation of FIG. 21 in the pressed-together state of the molded parts,

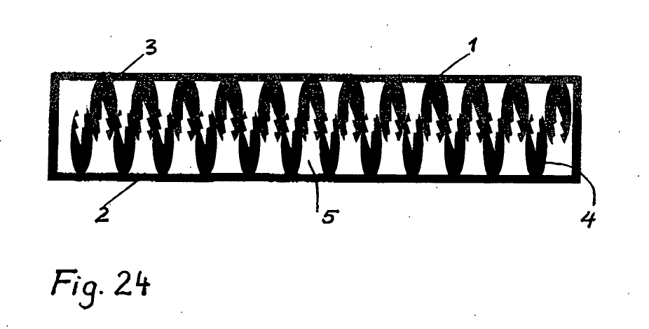

FIG. 24 shows a development of the variation of FIG. 22,

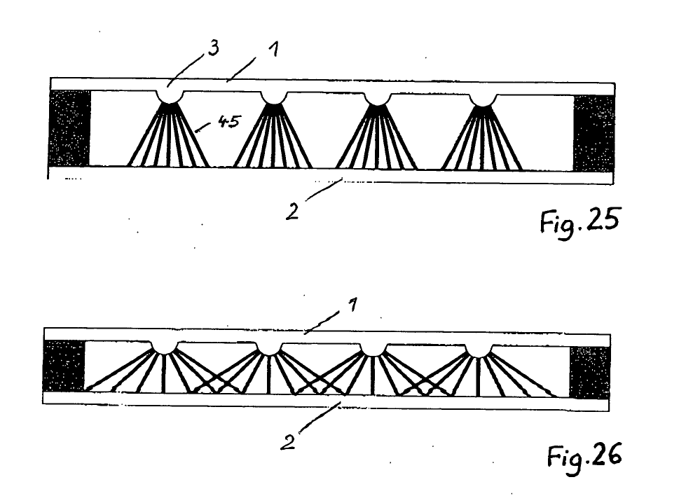

FIG. 25 shows a variation with a further special shape of the convexities in the separated state of the molded parts,

FIG. 26 shows the variation of FIG. 25 in the pressed-together state of the molded parts,

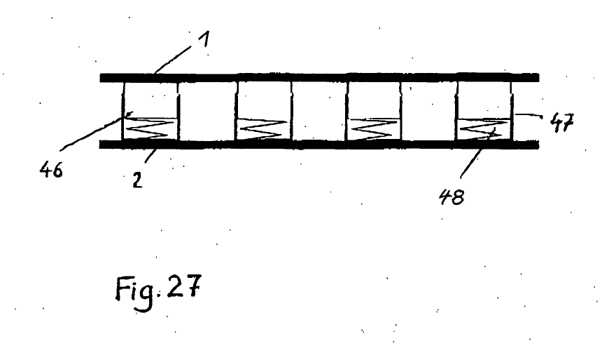

FIG. 27 shows a spacer for the molded parts,

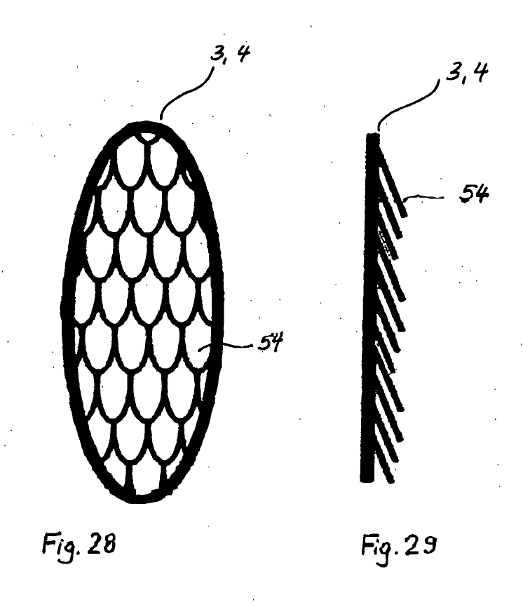

FIG. 28 shows an example of the surface of a convexity in plan view,

FIG. 29 shows the surface inside view,

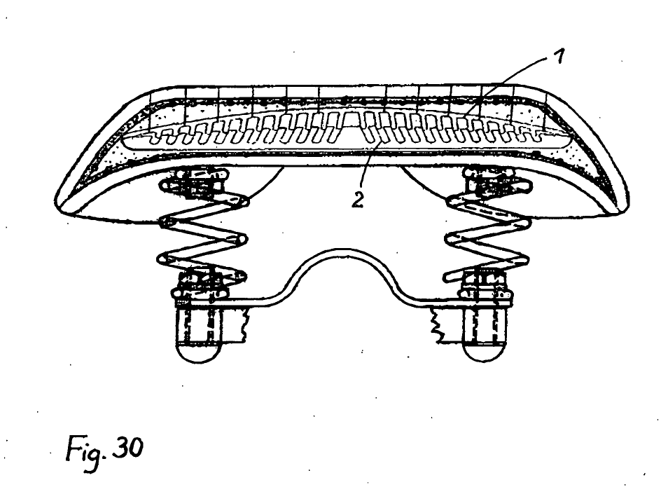

FIG. 30 shows a bicycle seat with the inventive device in a sectional representation as an example of an application,

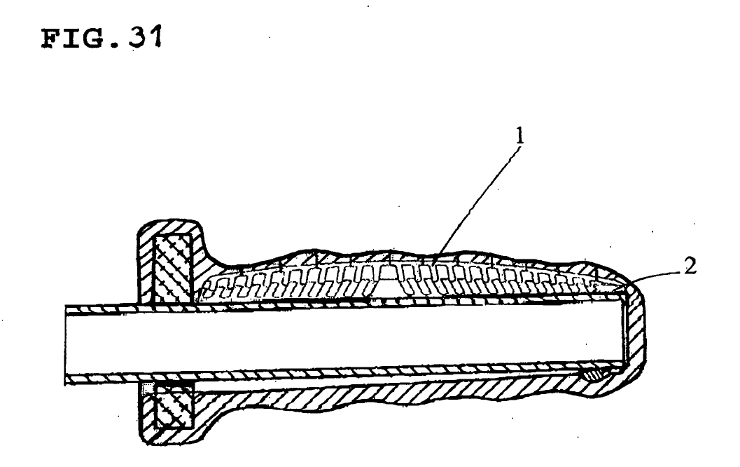

FIG. 31 shows a handlebar handle of a bicycle with the inventive device in cross section,

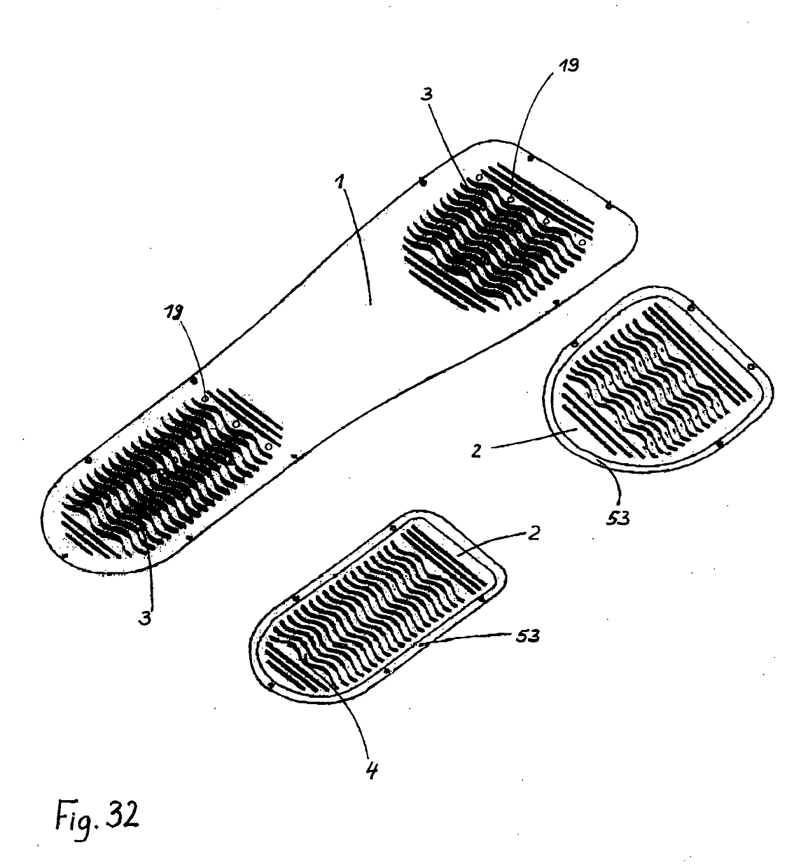

FIG. 32 shows an example of an insole with the heat-generating device,

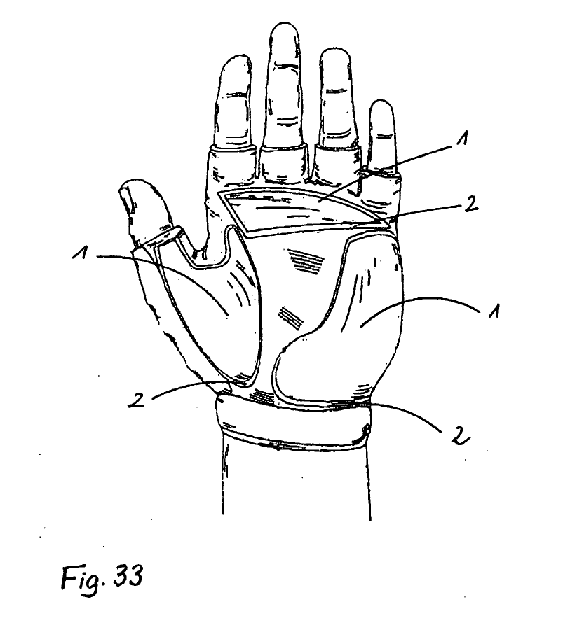

FIG. 33 shows a glove with the device,

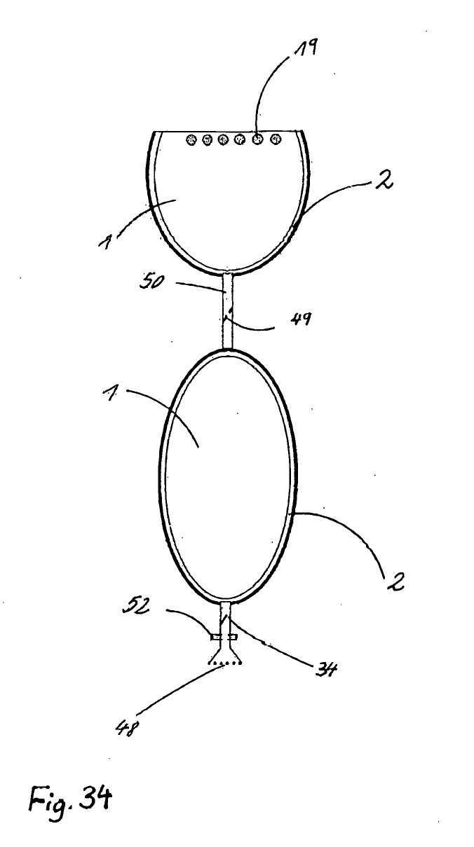

FIG. 34 shows a multipart structure of an insole of a shoe with the device and

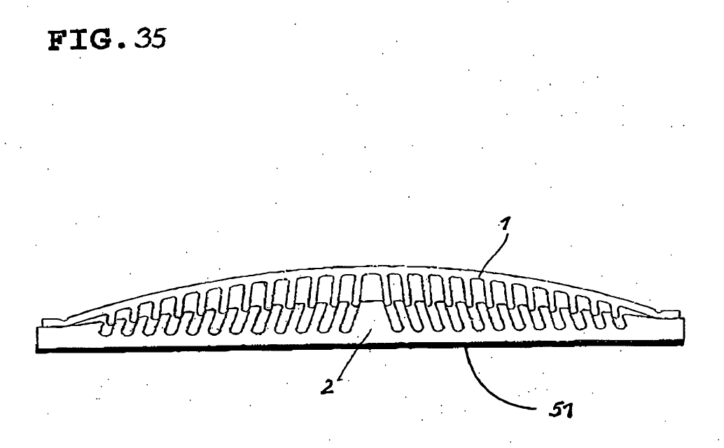

FIG. 35 shows a device similar to that of FIG. 1, with an additional insulation layer.

FIG. 1 shows an inventive device as a separate component in a sectional representation. The device consists of a first, upper molded part 1 and a second, lower molded part 2. Both molded parts 1 and 2 have annular, rib-like convexities 3 and 4, which, however, extend at a different angle of inclination. In the event of a pressure on the first molded part 1, the convexities 3 of the first molded part 1 shift into the recesses 5, which are formed between the convexities 4 of the second, lower molded part 2. Due to the inclined position of the convexities 4, compared to the convexities 3 of the first molded part 1, the latter slide against the resistance of the convexities 4 into the recesses 5. As a result of the movement, frictional heat is developed at the surface of the convexities 3, 4 and then passed on by the molded parts 1 and 2.

By way of example, FIG. 2 shows a cross-section through a latent heat storage system, which can be connected with the device and absorbs the frictional heat generated.

The latent heat storage system contains microscopically small plastic spheres 6, which contain a storage medium of wax in their core. By the action of heat or cold, the wax melts or solidifies in the small plastic spheres 6. If the device generates heat, the latent heat storage system absorbs this and, if the heat decreases, the latent heat storage system emits heat. The temperature remains constant during the phase conversion. The small plastic spheres 6 are bound in a carrier substance 7, such as an acrylate.

FIG. 3 shows a sole construction for a shoe in sectional representation as a field of application of the invention. The heat-generating device is integrated in the heel region of a middle sole 8. FIG. 4 shows the heel insert in a plan view. Here also, the ribs extend in an annular fashion. Experiments have shown that this heat generator heats by up to 7° during a running motion.

FIG. 5 shows a further sole construction in a sectional representation. An upper part 9 of the sole has compact but nevertheless flexible, downward-protruding convexities 10. The material of a lower part 11 of the sole has inwardly protruding concavities 12, which are disposed at an angle of inclination with respect to the convexities 10. The lower part 11, as well as the concavities 12, have a rough surface 13. This texture can be achieved by an overlay of material, such as a felt-like layer, or by a surface structuring. The lower part 11 and the upper part 9 are connected laterally with one another by a hinge 14. This can be seen well in FIG. 6. By folding the upper part 9 and the lower part 11 together, these two parts are arranged to lie on top of one another and are connected to one another by a lock 15. Due to the domed shape shown in FIGS. 6 and 7, a cavity 16 is formed when the upper part 9 and the lower part 11 are folded together. In order to improve wearing comfort, an anatomically shaped insole 17 was mounted above the sole construction.

If the upper part 9 and the lower part 11 are pressed together, for example, by walking on the heel, the convexities 10 are shifted into the concavities 12, which are disposed at an angle. Due to the inclined position of the concavities 12 with respect to the convexities 10, the slightly flexible convexities 10 can slide into the concavities 12 only by a contacting pressure against the resistance of the rough upper surface 13 and by bending the convexities 10. Due to the combination of contacting pressure and movement (sliding in against the resistance of the rough surface 13), frictional heat develops at the smooth surface of the convexities 10.

The convexities 10 may also be disposed so that they are constantly in the concavities 12 in the form of a piston and move up and down in these.

Due to the contact pressure or when setting down a foot, the upwardly arched sole construction is pressed downward due to the flexibility of the material and as a result of the deformation of the whole sole construction. Due to the compression, the air in the cavity 16 escapes through venting openings 18, which are in the upper part 9 as well as in the lower part 11 as well as through venting holes 19, which are in the insole 17.

By retracting the force, for example, when lifting the foot, the sole construction, due to the properties of its materials, due to the spacers or the enclosed air, as well as due to its shape, springs back into its original position. As a result of the tensile force of the upper part 9 and of the lower part 11, the convexities 10 are pulled against the resistance of the rough surface 13 and against the inclined emergence angle out of the concavities 12. Frictional heat is developed at the surfaces of the convexities 10 and the concavities 12 due to the tensile force. The cavity 16 enlarges and air is aspirated through the venting openings 18 as well as through the venting openings 19 of the insole 17.

FIG. 9 shows a second variation of the configuration of the convexities 10, which here are present in pin-like form, as well as their interaction with the concavities 12, here with surfaces, down which the pin-like convexities 10 slide when the foot is set down.

In order to be able to fit the sole construction into a middle sole 20, a recess 21 was formed in the latter, in that the sole construction rests on supporting edges 22, which consist of the material of the middle sole 20. The space below is sufficient for pressing the sole construction downward when it is subjected, for example, to a downward force, while the wearer of the shoe is walking. An outer sole 23, which consists of conventional, abrasion-resistant materials such as a rubber composite, is affixed to the underside of the middle sole 20. Spacers 24, which prevent permanent closing of the venting openings 18, are located at the underside of the insole 17. At the same time, the upper part 9, the lower part 11 and the into-one-another movement of the convexities 10 against the resistance of the rough surfaces 13 and the inclined entry angle of the concavities 12 absorb the bulk of the forces acting on the sole construction, for example, while walking. (If the space between the upper part 9 and the lower part 11 is filled, even by an enclosed gas or enclosed liquid). A portion of the kinetic energy is converted into frictional heat. The portion of the force, which cannot be absorbed by the sole construction, is absorbed by the yielding, compressible material of a zigzag-shaped hose 26, which is filled with a liquid 25, and by the yielding, compressible material of the middle sole 20, as well as by the outer sole 23. By compressing the hose 26, the liquid 25 therein is pressed through two one-way passage openings 27 into the also zigzag-shaped part of the hose 26, which is in the front region of the foot. FIG. 12 shows the course of the hose 26, which is embedded in the lower part 11. As the action of the force decreases or when the foot is raised or rolled off, the convexities 10 pull out of the concavities 12 with the development of frictional heat, the upper part 9 and the lower part 11, due to the elastic properties of their material, spring back into their initial position and, at the same time, the foot is repulsed. The hollow space 16 between the upper part 9 and the lower part 11 becomes larger. Due to the suction effect, air flows through the venting openings 18 and through the venting holes 19 of the insole 17. Air is drawn out of the interior of the shoe into the hollow space 16. Because of its flexibility, the hose 26 retracts into its original shape. A suction effect is developed. The liquid 25, previously pressed into the front region of the foot, is pressed back into the heel region by the suction effect of the material of the hose 26 as well as by the shift in weight on the front region of the foot, since the part of the hose 26 in the front region of the foot, as well as the part of the hose 26 in the heel region is provided at its respective ends with one-way passage openings 27, which permit the liquid 26 to flow through only in the same direction. Driven by the kinetic energy developed, for example, while running, the liquid 25 flows in one direction, comparable with blood circulation. The heat generated is passed on by the circulating liquid 25 to any place of the shoe. For example, it is now possible to pass on heat to the instep, the toes or into a bootleg. The hose 26 is prevented from bursting by air bubbles, which are enclosed in the cycle and are compressed when a very high pressure acts over the whole area of the foot and thus prevent a bursting of the hose 26 or of the one-way passage openings 27.

The hose 26 may be spot glued to the middle sole 20 by means a hot-melt adhesive. However, it is also possible that holding devices for the hose 26 are formed from the material of the upper part 9 and/or the lower part 11. An arrangement without the need for holding the hose 26 arises if the hose 26 is connected by partly gluing or welding the upper part 9 and the lower part 11, while the hose continues to extend in ring-shaped fashion.

In order to be able to use shoes with the inventive sole construction also when the temperatures are warmer or to replace wear and tear, it is possible to remove the sole construction from the recess 21 and to exchange it for a new one or for one with different properties, such as a lesser development of heat and/or a more intensive venting. One possibility, with which the generation of heat can be lessened, consists of introducing a connecting bolt 28 by insertion into openings 29, which are in the upper part 9 as well as in the lower part 11. The connecting bolt 28 has barbs 30, with which the upper part 9 and the lower part 11 can be connected with one another. Depending on the construction of the connecting bolt 28, the movement of radius is reduced and, with that, the evolution of heat is lessened or prevented completely. At the upper side of the connecting bolt 28, there is an indentation 31, with which the connecting bolt 28 can be rotated, for example, with a coin. If the openings 29 are slot-shaped, the barbs 30 do not catch on anything when the connecting bolt 28 is rotated and the latter can be removed simply by pulling it out. So that the inserted connecting bolt 28 does not show through, the upper part 9 is provided at the place of the openings 29 with a material recess 32.

The upper part 33 of the shoe, which is connected firmly with the middle sole 20 and optionally with the sole construction, consists of materials typical for this application, such as leather or textile fabrics.

The thickness of the material of the sole construction as well as of the hose 26 and of the one-way passage openings 27 may vary depending on the area of use of the shoe. For example, for the wearing comfort of a leisure shoe, it is desirable that the heat-generating properties achieve a maximum effect when walking normally. This is achieved by selecting a thinner or more elastic material. On the other hand, for sports shoes, it is desirable that a maximum heat distribution as well as heat generation is achieved during sporting activities, such as jogging and sprinting, and not only or already when walking normally. This is achieved by a material, of which the sole construction and the hose 26 as well as the one-way passage openings 27 consists, which reaches a maximum of frictional heat and of heat distribution only under extreme loads, such as when the foot is set down after a jump.

2The sole construction advisably is formed by injection molding methods in one part, which consists, for example, of a stable, yielding plastic, such as nylon or PET.

In a further development of the invention of FIG. 13, the sole construction contains at least one inlet valve 34 and at least one outlet valve 35, which may be constructed identically, but are installed in different directions with respect to the hollow space 16. If the stress on the sole construction is relieved, for example, when the foot is a raised, the hollow space 16 between the upper part 9 and the lower part 11 increases in size and a reduced pressure is produced; the inlet valve 34, connected with the interior of the shoe, is closed. Outside air can flow into the hollow space 16 through the inlet valve 34, for example, in the middle sole 20. The flexibility of the material, of which the sole construction consists, changes with the temperature of the outside air. If the temperature of the outside air is low, the flexibility of the material decreases, so that the resistance, with which the convexity 10 slides into the concavity 12, is increased; frictional heat is generated to a high degree and heats the fresh air in the cavity 16. If a stress is placed on the sole construction, for example, when the foot is lowered, the hollow space 16 is reduced in size, and overpressure develops, the inlet valve 34, which is, for example, in the material of the middle sole 20, closes and the heated fresh air flows through an outlet valve 35 into the interior of the shoe.

On the other hand, if the temperature of the outside air is high or if the sole construction was already heated by frictional heat, the maternal of the sole construction, especially that of the convexity 10, becomes flexible so that the resistance with which the convexity 10 slides in the concavity 12, is reduced and frictional heat is generated to a lesser extent.

The heat generation of the sole construction is regulated automatically by these material properties. The outside air is heated automatically, if required, before it is pumped into the interior of the shoe.

Penetration of water and/or dirt into the sole construction is prevented, for example, by a microfiber layer.

The temperature sensitivity can be increased even more if the convexities 10 are constructed in the form of lamellas, as shown in FIGS. 15 and 1.

Aside from the lamellas, FIGS. 14 and 15 also show the possibility, offered by the inventive sole construction, of producing a heat-generating insole. FIG. 14 shows such an insole in a plan view and FIG. 15 shows it in a sectional representation.

The upper part 9 and the lower part 11 consists here of a flexible plastic. If a stress is placed on the sole construction, for example, when the foot is lowered, spacers 36 between the upper part 9 and the lower part 11 are compressed. The upper part 9 sinks with the resistance, with which the convexity 10, formed as lamellas, slides into the concavity 12 and frictional heat is generated. If the sole construction is heated by frictional heat, the material of the sole construction, especially the convexity 10, becomes flexible and the resistance, with which the convexity 10 slides into the concavity 12, is reduced. This brings about a constant generation of heat. Maximum temperatures are not exceeded, independently of the stressing interval. If the stress on the sole construction is relieved, for example, when the foot is raised, the spacers 35 expand and the upper part 9 is raised, as a result of which the convexity 10 is forced out of the concavity 12. The frictional heat can be delivered more rapidly and more uniformly to the interior of the shoe or to the foot through the venting openings 18, which are formed, advantageously, as perforations. Different temperature regions may also be disposed over the surface of the insole. This would be achieved if the convexities 10 and/or the concavities 12 are different in nature. Advantageously, the upper part 9 and the lower part 11 are joined together by gluing or by thermoplastic fusing.

FIG. 16 shows a different form of structuring the molded parts 1 and 2. The structures are formed here only by flat, arc-shaped convexities 37, 38, which are in contact with one another at their points of inflection and generate frictional heat there by an upward and downward movement.

A further variation of the molded parts 1 and 2 with nap-like convexities 39, 40, is shown in FIGS. 17 and 18. The convexities 39, 40 are mutually offset about a raster grid. There are even smaller convexities 41, 42 between the convexities 39, 40. The advantage of this arrangement is that both molded parts 1 and 2 have the same structure and may either represent identical parts or be cut from a common raw material.

FIGS. 19 and 20 show a device configured as an air cushion. The molded parts 1 and 2 are welded together at their edges 43, so that an air-tight hollow space is formed. Such an air cushion generates significantly higher restoring forces than do devices, the restoring force of which is produced exclusively by the elasticity of the molded parts 1, 2.

In order to achieve more heat storage, the cavity may also be filled with a gel or a liquid.

A further variation is shown in FIG. 21. Here the convexities 3 in the upper molded part 1 are opposite crosswise disposed naps 44, which also have a higher restoring force.

FIGS. 22 and 23 show a device with barrel-shaped convexities 3, 4, which, in turn, may be disposed in annular fashion or are present as naps disposed on a raster grid.

According to FIG. 24, the convexities 3, 4 are split. The advantage of this measure is that the restoring forces, when there is wear of the plastic material at the friction surfaces, bring about an adjustment. Even the self-regulating effect is supported. The device once again may be configured as a closed construction, optionally filled with a gel, a gas or a liquid.

FIGS. 25 and 26 show a further variation. The convexities 3 in the upper molded part 1 end in brush-like continuations 45, which are shifted laterally when the molded parts 1, 2 move towards one another.

FIG. 27 shows spacers 46 for keeping the molded parts 1 and 2 apart. The spacers 46 are configured as sleeves 47, in which a spring 48 ensures the necessary restoring force.

FIGS. 28 and 29 show an example of a surface structure of the convexities 3 and/or 4, which have a scale-like shape (scales 54) and so increase the frictional resistance significantly.

FIG. 30 shows a cross-section through a bicycle seat, in which the inventive device is integrated for generating heat. Due to the constant movement, which a bicycle seat experiences, the device ensures that the bicycle seat remains pleasantly warm even at low temperatures. The bicycles seat can be constructed so that the device for generating heat can be removed so that it can be replaced by a foam core when the outside temperatures are warmer.

FIG. 31 finally shows a cross-section through a bicycle handle with an integrated device for generating heat. The handle is heated if it is compressed and, at the same time, deformed elastically by the shaking movements of the moving bicycle.

FIG. 32 shows a molded part, which is formed here as part of an exchangeable insole. The wearing properties of a shoe can be changed depending on the insole that has been inserted. The insole is connected with the internal sole by locking mechanisms, such as Velcro surfaces or mechanical locking mechanisms. Advisably, the molded parts 1, 2 have seals 53 at their edges, which enable air to circulate through venting holes 19.

The convexities 3, 4 are undulating here, as a result of which the frictional resistance is increased significantly.

The lower molded parts 2 may be fixed components of a shoe sole.

FIG. 33 shows a possible area of use in textiles, such as gloves. The molded parts 1 are applied here on the outside and may be exchanged for others. The glove may be a work glove or a ski glove.

FIG. 35 shows a multipart construction of the internal sole of a shoe, which generates heat, ventilates the foot and, at the same time, absorbs impacts.

In the center, the construction has a connecting pipe 50, in which there is a resistance 49, which makes possible a controlled escape of displaced air from the rear to the front region of the foot. With that, the impact-absorbing properties are changed in the rear region of the foot.

The air from the venting holes 19 in the front region of the foot escapes from the front region. This has the advantage that especially the cold-sensitive toes are heated.

The rear region aspirates outside air when the foot is raised. In order to prevent penetration by dirt or water, the air inlet opening was closed off with a membrane 48. The amount of air, which is aspirated when the stress on the rear region is relieved, can be modified by the flow-control valve 52. This makes a selective control of heat possible. An inlet valve 34 prevents escape of the aspirated air to the outside.

FIG. 35 shows a device similar to that of FIG. 1, the only difference being that there is an insulating layer 51, which reflects the heat generated in the direction of the body, underneath the molded part 2 at the bottom.

### LIST OF REFERENCE SYMBOLS OF THE KINETIC SOLE CONSTRUCTION

1 (first) molded part
2 (second) molded part
3 convexity
4 concavity
5 recess
6 small plastic spheres
7 carrier substance
8 middle sole
9 upper part
10 convexity
11 lower part
12 concavity
13 surface
14 hinge
15 lock
16 hollow space
17 insole
18 venting opening
19 venting opening
20 middle sole
21 recess
22 supporting edges
23 outer sole
24 spacer
25 liquid
26 hose
27 one-way passage opening
28 connecting bolt
29 opening
30 barb
31 indentation
32 material recess
33 upper part of shoe
34 inlet valve
35 outlet valve
36 spacer
37 convexity
38 convexity
39 convexity
40 convexity
41 convexity
42 convexity
43 edges
44 naps
45 continuations
46 spacer
47 spring
48 membrane
49 resistance
50 connecting pipe
51 insulating layer
52 flow-control valve
53 seal
54 scales

1. Device for converting movement energy into heat, characterized by two molded parts (1, 2), which are disposed one behind the other in the main direction of movement and of which at least one consists of a polymeric plastic and can be moved elastically and which are structured at their mutually opposing surfaces, so that, when the molded parts (1, 2) move towards one another, a frictional heat-producing surface friction results.

2. The device of claim 1, characterized in that a first molded part (1) has rib-like or nap-like convexities (3), which engage in opposite recesses (5) between convexities (4) of a second molded part (2), so that opposing convexities (3, 4) of the first and second molded parts (1, 2) rub against one another.

3. The device of claim 1, tracked dice and that the convexities (3, 4) are constructed barrel-shaped.

4. The device of claim 1, characterized in that the convexities (3, 4) are split.

5. The device of claim 1, characterized in at the convexities (3) of the first molded part (1) are nap-shaped and engage between crosswise disposed naps (44) of the second molded part (2).

6. Device of claim 1, characterized in that the convexities (3) of a molded part (1, 2) end in brush-like continuations (45).

7. The device of claim 1, characterized in that the convexities (3) and the opposite recesses (5) have different angles of inclination.

8. The device of claim 1, characterized in that the convexities (3) and the opposite recesses (5) are created in the ring-shaped fashion.

9. The device of claim 1, characterized in that that a hollow space, formed between the first and second molded parts (1, 2), is filled with air, a gas, a gel, a powder or a liquid.

10. The device of claim 1, characterized in that the convexities (3) and the opposite recesses (5) are created strip-shaped.

11. The device of claim 1, characterized in that the surface (13) of at least one of the molded parts (1, 2) is a roughened or structured.

12. The device of claim 1, characterized in that at least one of the molded parts (1, 2) is connected with a heat-storing material.

13. The device of claim 12, characterized in that the heat-storing material is a latent heat storage system with a microencapsulated storage medium.

14. The device of claim 13, characterized in that the latent heat storage system is provided with an indicator dye.

15. The device of claim 1, characterized in that the first and second molded parts (1, 2) are at least partly spaced apart in the unstressed state.

16. The device of claim 15, characterized in that the first and second molded parts (1, 2) are spaced apart from one another by spacers (36).

17. The device of claim 1, characterized in that the first and second molded parts (1, 2) are produced from one piece and are connected with a hinge (14).

18. The device of claim 17, characterized in that the first and second molded parts (1, 2) are connected to one another by a lock (15).

19. The device of claim 1, characterized in that the first and second molded parts (1, 2) are glued to one another.

20. The device of claim 1, characterized in that the first and second molded parts (1, 2) are connected to one another by thermoplastic melting.

21. The device of claim 1, characterized in that at least one of the molded parts (1, 2) is provided with an indicator dye.

22. The device of claim 1, characterized in that the molded plus (1, 2) consist of an elastic plastic.

23. The device of claim 1, characterized in that metal in the form of a wire and/or a metal powder is within the material of the molded parts (1, 2).

24. The device of claim 1, characterized in that the molded parts (1, 2) consist of an electroactive or thermoactive polymer.

25. The device of claim 1, characterized in that it is part of a sole construction for shoes and that the first molded part (1) forms an upper, elastically constructed sold part (9) and the second molded part (2) forms a lower sole part (11), the sole parts (9, 11) being provided at least in the heel region of the shoe.

26. The device of claim 25, characterized in that, within or beneath the lower sole part (11), there is a hose (26), which extends from the heel region at least up to a further part of the shoe, is filled with a liquid (25) and in the annular extent of which at least one one-way passage opening (27) is disposed.

27. The device of claim 26, characterized and that the hose (26) consists of an elastic material.

28. The device of claim 26, characterized in that the hose (26) is connected with a latent heat storage system.

29. The device of claim 26, characterized in that the hose (26) is provided with an indicator dye.

30. The device of claim 26, characterized in that the further part of the shoe is the front foot area, the toe area, the instep area or the calf area.

31. The device of claim 25, characterized in that the upper and the lower sole parts (9, 11) are embedded in a further part (20) of the sole.

32. The device of claim 31, characterized in that the upper and the lower sole parts (9, 11) are held on supporting edges (12) at the further sole part (20).

33. The device of claim 25, characterized in that the upper and the lower sole parts (9, 11) are connected with one another to form an insole.

34. The device of claim 25, characterized in that the upper and lower sole parts (9, 11) are constructed horseshoe-shaped.

35. The device of claim 25, characterized in that the upper and lower sole parts (9, 11) have venting openings (18).

36. The device of claim 35, characterized in that the venting openings (18) are closed off with at least one valve.

37. The device of claim 36, characterized in that the venting openings (18) are closed off with at least one inlet valve (34) and one outlet valve (36).

38. The device of claim 25, characterized in that the upper and the lower sole parts (9, 11) can be connected with a connecting element (28).

39. The device of claim 38, characterized in that the connecting element (28) has rectangular barbs (30), which engage behind slot-shaped recesses (29) in the low part (11) of the sole.

40. The device of claim 25, characterized in that the upper and the lower sole parts (9, 11) are connected to one another by gluing.

41. The device of claim 25, characterized in that the upper and the lower sole parts (9, 11) are connected with one another by thermoplastic melting.

42. The device of claim 25, characterized in that an anatomically shaped insole is disposed above the upper sole pot (9).

43. The device of claim 42, characterized in that the insole (17) has venting holes (19).

44. The device of claim 43, characterized in that the insole (17) has spacers (24) at its underside.

45. The device of claim 26, characterized in that the hose (26) is produced partly by welding or gluing the sole parts (9, 11).

46. The device of claim 26, characterized in that holding devices for the hose (26) are formed from the material of the sole parts (9, 11).

47. The device of claim 25, characterized in that the sole parts (9, 11) consist at least partly of hard rubber.

48. The device of claim 25, characterized and that the sole parts (9, 11) consist at least partly of nylon.

49. The device of claim 25, characterized in that the sole parts (9, 11) consist at least partly of EVA.

50. The device of claim 25, characterized in that the sole parts (9, 11) consist at least partly of a carbon fiber composite.

51. The device of claim 1, characterized in that it is part of the construction of a bicycle seat.

52. The device of claim 1, characterized in that it is part of a construction of a saddle.

53. The device of claim 1, characterized in that it is part of a construction of a bicycle handle.

54. The device of claim 1, characterized in that it is part of a construction of a glove.

55. The device of claim 1, characterized in that it is part of a construction of the upper part of a shoe.

56. The device of claim 1, characterized in that at least one of the molded parts (1, 2) is connected with a heat-insulating material (51).

57. The device of claim 1, characterized in that at least one of the molded parts (1, 2) is a component of an insole (17).

58. Method for converting movement energy into heat, characterized in that the movement energy is converted into heat by the friction of mutually opposing structured surfaces of two molded parts, of which at least one consists of an elastic, polymeric plastic.
